(19) United States
(12) Patent Application Publication
(10) Pub. No.: US 2013/0325741 A1
(43) Pub. Date: Dec. 5, 2013

(54) System And Method To Synchronize Shipment Delivery

(71) Applicants: Geoffrey Smalling, San Anselmo, CA (US); William Clifford, San Francisco, CA (US)

(72) Inventors: Geoffrey Smalling, San Anselmo, CA (US); William Clifford, San Francisco, CA (US)

(73) Assignee: Wine.com, Inc., San Francisco, CA (US)

(21) Appl. No.: 13/484,262

(22) Filed: May 30, 2012

(51) Int. Cl. G06Q 10/08

(52) U.S. Cl. 705/337

(57) ABSTRACT

A system to synchronize delivery of shipments is described that includes modules. The modules including a rule module configured to determine at least two merchandise origin locations based on an input received from a user device. A date determination module coupled with the rule module. The date determination module configured to receive the at least two merchandise origin locations from the rule module and configured to determine at least one delivery date for delivery to a merchandise destination location such that a first merchandise at a first merchandize origin location and a second merchandize at a second merchandise origin location are scheduled to arrive at said merchandise destination location on the determined at least one delivery date. And, a format module configured to transform the at least one delivery date into a format for the user device.

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever

### FIELD

Embodiments of the invention relate to a system for determining a delivery date of a shipment. In particular, embodiments of the invention relate to a system to synchronize more than one shipment to arrive on a delivery date.

### BACKGROUND

An online shopping system provides a user the benefit of shopping for merchandise from any location. Once the user purchases merchandise from such an online shopping system, the system provides options for shipping the merchandise to a user such as ground shipping, two day shipping, or overnight shipping. In some cases, an online shipping system might provide a delivery window or range including many dates that merchandise might be delivered. But, such a system does not provide a user the ability to select a date for delivery. In additions, such systems fail to synchronize a date for delivery of an order that requires shipping more than one merchandise separately, for example from separate locations. As such, current shopping systems provide no certainty to a user at the point of sale that merchandise will be delivered on any a specific date and that all merchandise will arrive on the same day.

### SUMMARY

A system to synchronize delivery of shipments is described. The system including memory, one or more processors, and one or more modules stored in memory and configured for execution by the one or more processors. The modules including a rule module configured to determine at least two merchandise origin locations based on an input received from a user device. A date determination module coupled with the rule module. The date determination module configured to receive the at least two merchandise origin locations from the rule module and configured to determine at least one delivery date for delivery to a merchandise destination location such that a first merchandise at a first merchandize origin location and a second merchandize at a second merchandise origin location are scheduled to arrive at said merchandise destination location on the determined at least one delivery date. And, a format module configured to transform the at least one delivery date into a format for the user device.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of a user device according to an embodiment;

FIG. 2 illustrates a block diagram of a distributed system according to an embodiment;

FIG. 3 illustrates a flow diagram for determining shipping information for a plurality of merchandise according to an embodiment;

FIG. 4 illustrates a flow diagram for determining shipping information and delivery dates for a plurality of merchandise according to an embodiment;

FIG. 5 illustrates a document generated to display determined shipping options and determined delivery dates according to an embodiment;

FIG. 6 illustrates a list of determined shipping options and delivery options according to an embodiment;

FIG. 7 illustrates a graphic user interface for selecting a delivery date according to an embodiment;

FIG. 8 illustrates a graphic user interface for a shopping cart that includes determined shipping information according to an embodiment;

FIG. 9 illustrates a graphic user interface for a shopping cart that includes determined shipping information with format information;

FIG. 10 illustrates a block diagram of a system according to an embodiment; and

FIG. 11 illustrates a block diagram of a client according to an embodiment.

### DETAILED DESCRIPTION

Embodiments of a system to determine shipping information are described. Specifically, an embodiment of a system configured to determine shipping information based on factors including, but not limited to, type of merchandise, location of merchandise, user preferences, business rules or other factors. Based on merchandise selected and/or user preferences, the system, according to an embodiment, determines shipping information available for one or more merchandise. According to an embodiment, the system further determines a delivery date for merchandise based on shipping options available.

An embodiment further includes a system configured to determine one or more delivery dates to synchronize shipment of merchandise shipping from different locations such that all merchandise is scheduled to arrive on the same date. As such, an embodiment of a system synchronizes split shipments to arrive on the same day. This provides the benefit to a user of such a system the convenience of knowing at the point of sale that all merchandise is scheduled to arrive on a certain day selected by the user.

An embodiment of a system includes an online shopping system that sells merchandise that is regulated. For example, such a system may sell alcohol products including, but not limited to, wine, spirits, and beer. Because of regulations, certain products, such as alcohol products, require an adult signature for the products to be delivered. As such, a system according to an embodiment is configured to generate a delivery date to a user at the point of sale such that all merchandise ordered is scheduled to arrive on the same date. For an embodiment, the determined date for delivery is selected by the user. This informs the user with a level of certainty as to when the merchandise will arrive and minimizes the time a user must be available to sign for delivery. Embodiments of the system provide an online retailer more repeat business from users because of the higher level of service based on the ability of a user to select a delivery date that is convenient to them. In addition, embodiments of the system provide more control to a retailer over the shipping of merchandise and costs associated with shipping. This in turn enables better control over user expectations.

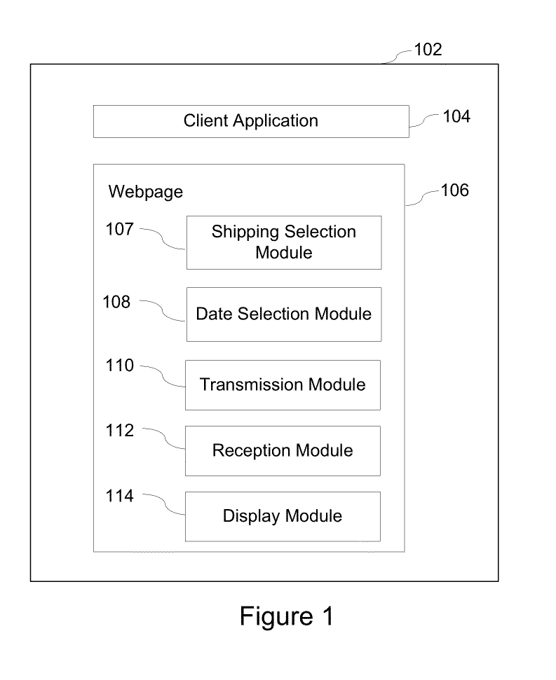

FIG. 1 illustrates a block diagram of a user device according to an embodiment of a system. According to an embodiment, user device 102 may be any device for viewing a document that includes information including, but not limited to, a mobile phone, a computer, a tablet computer, a personal digital assistant (PDA) or other mobile device. A document includes, but is not limited to, a webpage, a remotely located document, a dynamically generated document, or other document including information. A user device 102, according to an embodiment, includes one or more client applications 104 that may be used to communicate through a network. For some embodiments, a client application 104 may be an application for viewing, searching for, or using resources over a communication network. According to an embodiment, a client application 104 includes a web browser, an application, a script and/or an executable file. Such a client application 104, for an embodiment, may be used for retrieving information from a remote source to provide information to a user device 102 and for retrieving and viewing a document, such as one or more webpages 106.

According to an embodiment, a client application 104 retrieves a webpage 106 using address information including, but not limited to, a domain name, an internet protocol address (“IP address”), a media access control (“MAC”) address, or a uniform resource locator (“URL”). For example, a client application 104 retrieves a webpage 106 from an online shopping system. As illustrated in FIG. 1, the retrieved or accessed webpage 106 may include a shipping selection module. According to an embodiment, a shipping selection module 107 may be included in a webpage 106 after a user selects merchandise for shipping or purchase. Merchandise may be one or more items. For example, a shipping selection module 107 may be included in a webpage configured as a shopping cart for an online shopping system. A shipping selection module 107, for an embodiment, is configured to request shipping options for merchandise.

For some embodiments, a shipping selection module 107 is configured to receive input from a user device 102 indicating a selection of one or more shipping options. Examples of shipping options includes carrier service, shipping speed, packaging, conditions on shipping, or other aspects related to the shipping of merchandise. For an embodiment, one or more carriers may be included in the a list of shipping options based on the ability to ship to a chosen destination, types of services offered, cost of services or other aspects of a carrier. Shipping speed options may include a type of shipping service such as ground, 2 day, 3 day, overnight, overnight by 3:00 p.m., overnight by 10:30 a.m., or other shipping service level. Examples of conditions on shipping that may be included in a list of shipping options include, but are not limited, shipping based on weather forecasts, shipping with ice packs, shipping with insulation, holding shipment based on current weather conditions or forecasted weather conditions, and other aspects of shipping.

For an embodiment, a shipping section module 107 may be configured to provide a set of shipping options upon a determination that a certain type of merchandise is to be shipped. For example, the merchandise may include perishable items or items sensitive to temperature so only shipping options that limit shipping time may be made available for selection. For such items, shipping options may include, but are not limited to, including ice packs, including insulation, offering shipping methods that limit shipping time to less than a week, or including other packing materials to minimize effects from temperature during shipping. For another embodiment, a shipping selection module 107 is configured to request shipping options from a system or server in response to receiving an input. The input may be a user input for example selecting an icon on a screen that opens a shopping cart webpage, a user selecting a button with a user interface to request shipping options, responsive to an item of merchandise being selected for purchase, responsive to other user interactions with a webpage, or other input corresponding to selecting merchandise for shipping or purchase.

According to an embodiment, a shipping selection module 107 includes a client-side script embedded in a webpage 106. The script may be written or coded using Perl, PHP, ASP.NET, Java, VBScript, or any other scripting language. For another embodiment, webpage 106 may include a reference to an external program or script. For a specific embodiment, shipping selection module 107 is a function in a markup language used to create a webpage 106, such as a function in HyperText Markup Language (“HTML”), in Extensible HyperText Markup Language (“XHTML”) or other language.

The embodiment in FIG. 1 also includes a date selection module 108. According to an embodiment, a date selection module 108 is configured to request one or more dates available for delivery of merchandise selected for shipping or purchasing. A date selection module 108, according to an embodiment, is configured to request one or more delivery dates responsive to an input indicating a preferred shipping option. The input may be a user input, for example, a user selecting an icon on a screen to select one or more shipping options, responsive to an item of merchandise being selected for purchase, or other user interactions with a webpage. According to an embodiment, date selection module 108 is implemented using techniques similar to those described herein for other modules. For a specific embodiment, date detection module 108 is a function in a markup language used to create a webpage 106, such as a function in HTML, XHTML, or other language.

According to an embodiment, a date selection module 108 is configured to receive an input to select one or more delivery dates received by a user device 102 in response to a request for delivery dates. As described above, an input may be a user input, for example, a user selecting an icon on a screen to select a delivery date, responsive to a user inputting text in a text box, or other user interactions with a webpage. According to an embodiment, a date selection module 108 is implemented using techniques similar to those described herein for other modules.

As illustrated in FIG. 1, the embodiment may also include a transmission module 110. A transmission module 110 is configured to transmit one or more requests and one or more selections such as a shipping options request from a shipping selection module 107, one or more selected shipping options corresponding to an input received by a shipping selection module 107, a date request from a date selection module 108, and one or more selected delivery dates corresponding to an input received by a date selection module 108. A transmission module 110, according to embodiments, may be a script, a program, or a function associated with a webpage 106 using techniques similar to those described with regard to embodiments of the shipping selection module 107. According to an embodiment, a transmission module 110 transmits a request and/or a selection through a communication network back to a system or server, such as an online shopping system. According to an embodiment, a transmission module 110 transforms any request or selection into a format for the online shopping system.

A reception module 112, according to an embodiment, is configured to receive content information responsive to a request sent by a transmission module 110. According to an embodiment, reception module 112 may be a script, a program, or a function associated with a webpage 106 using techniques similar to those described with regard to embodiments of the shipping selection module 107. Such content information may include, but is not limited to, information that relates to shipping options, delivery dates, weather conditions, product information, and other information related to products or services offered by a system. For an embodiment, a reception module 112 is configured to receive shipping options based on a type of merchandise selected.

The embodiment illustrated in FIG. 1 also includes a display module 114. According to an embodiment, a display module 114 may be a script, a program, or a function associated with a webpage 106 using techniques similar to those described with regard to embodiments of a shipping selection module 107. According to some embodiments, display module 114 may also include markup language, cascading style sheets (“CSS”), or templates used by a client application 104, such as a browser to transform or to render the content information in a format for viewing on a user device 102.

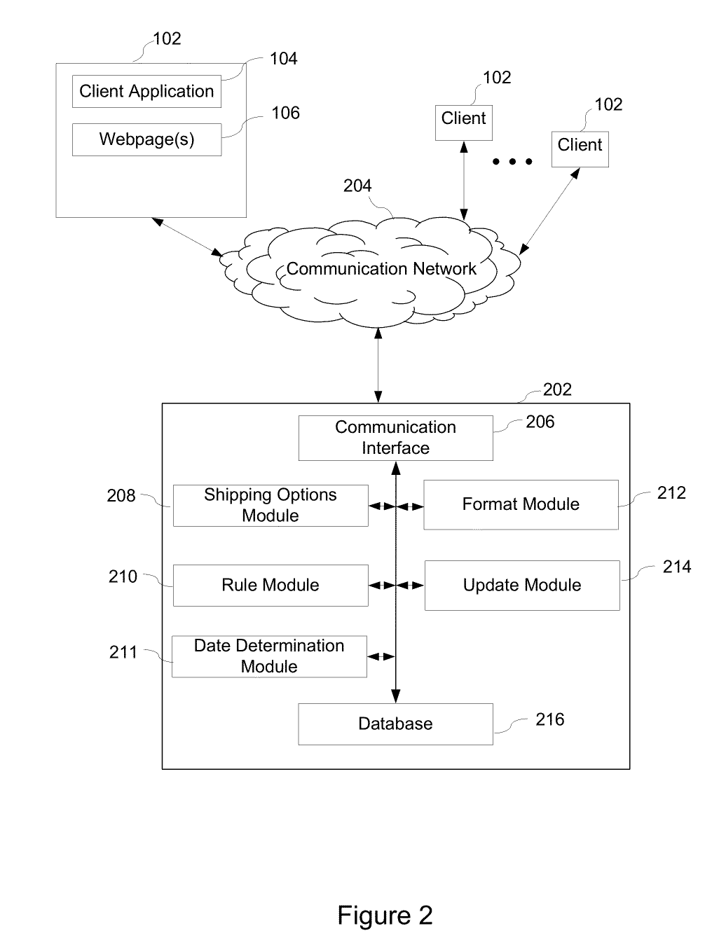

FIG. 2 illustrates a distributed system including a user device 102 coupled with a system 202, system 202 may include, but is not limited to, an online shopping system, a retail system, a shipping system, or other system for determining delivery dates for a plurality of merchandise some of which is shipped from different locations. According to an embodiment, a user device 102 is coupled with a system 202 through a communication network 204. A communication network 204 includes, but is not limited to, a wide area network (“WAN”), such as the Internet, a local area network (“LAN”), wireless network, or other type of network. According to embodiments, one or more user devices 102 may be communication with system 202 through a communication network 204.

A system 202, according to an embodiment, includes a communication interface 206 configured to communicate with one or more user devices 102 or other clients through a communication network 204 using communication protocols. For some embodiments, a communication interface 206 manages one or more communication sessions between a system 202 and one or more user devices 102. A communication interface 206 may also convert or package data or content information into the appropriate communication protocol depending on the protocol used by a user device 102. According to some embodiments, a communication interface 206 may be configured to use one or more communication protocols for one or more communication layers, such communication protocols include, but are not limited to, hypertext transfer protocol (“HTTP”), transmission control protocol (“TCP”), Internet Protocol (“IP”), user datagram protocol (“UDP”), file transfer protocol (“FTP”), or any other protocol.

A system 202, according to an embodiment, includes a shipping options module 208 that is coupled with a communication interface 206. The shipping options module 208, according to some embodiments, is configured to receive a request for shipping information that includes a request for shipping options from a user device 102. For some embodiments, a request for shipping options may include an indication of the merchandise for shipping, such as a merchandise reference. In another embodiment, the request for shipping options may be a request to view the shopping cart. For some embodiments, a request may include information that corresponds to a destination address including, but not limited to, one of or any combination of a state, a city, a county, a zip code, a street address, a street number, a building name, a country, a postal code, latitude and longitude, or other information related to a location. For an embodiment, a shipping options module 208 is configured to determine the shipping options available to deliver merchandise to a location, such as a merchandise destination location received from a user device 102. Shipping options, according to an embodiment, may be a predetermined list or may be generated in response to a request received from a user device 102.

As described above, shipping options include, but are not limited to, carrier service, shipping speed, packaging, conditions on shipping, or other aspects related to the shipping of merchandise. For an embodiment, a shipping options module 208 may determine shipping options based on input from a rule module 210. According to an embodiment, a rule module 210 is configured to determine one or more rules based at least in part on information received from a user device 102. Information received from a user device 102 may include location information, information related to merchandise, information related to shipping options, information related to delivery dates, or other information related to merchandise or services offered by a system 202. For an embodiment, a rule module 210 is configured to determine one or more rules based on business aspects including, but not limited, one or more of a preferred shipping location, a preferred warehouse, a preferred warehouse state, a preferred shipping options, a price, a gross margins, a profit margin, a minimum quantity, a cost of shipping, a shipping rule based on a merchandise origin location, a shipping rule based on a merchandise destination location, a user preference, a user history, a shipping time to a merchandise destination location, a merchandise destination location, and other factors related to shipping merchandise.

According to an embodiment, a rule module 210 is configured to receive information related to the location of merchandise, the user device location, the shipping destination and/or other information related to shipping. A rule module 210 references one or more database 216 or lookup table, according to some embodiments, that includes rules or conditions used to determine available shipping options. According to some embodiments, a database 216 or lookup table may include one or more rules that correspond to one or more references or values. For some embodiments, a reference or value includes a pointer or address location of a list of available shipping options. For some embodiments, a database 216 or lookup table may be one of or a combination of one or more memories, one or more servers within system 202, or one or more servers remotely located from system 202. According to other embodiments, rule module 210 may access more than one database 216 or lookup table. Yet another embodiment includes a rule module 210 accessing a database 216 that includes a list of available shipping options preconfigured based on one of or a combination of a merchandise destination location and a type of merchandise being shipped.

According to an embodiment, a rule module 210 is configured to determine the shipping times for merchandise from a merchandise origin location to a merchandise destination location. For an embodiment, a rule module 210 is configured to receive information from a user device 102. Such information may include, but is not limited to, a shipping address or merchandise destination location to ship one or more merchandise selected by a user. For an embodiment, a user device 102 is configured to request a merchandise destination location from a user. For example, a webpage may be configured to include a text box to receive input through one or more user interfaces for providing a merchandise destination location. According to an embodiment, a shipping selection module 107 is configured to receive one or more merchandise destination locations and transmit the one or more merchandise destination locations to a system 202. According to an embodiment, a shipping selection module 107 is configured to receive a merchandise destination location that corresponds to a particular selected merchandise. As such, each merchandise may have a distinct merchandise destination location or some of the selected merchandise may correspond to a first merchandise destination location and some of the selected merchandise may correspond to a second merchandise destination location. As such, a shipping selection module 107, according to an embodiment, is configured to receive any number of merchandise destination locations to correspond with any number of merchandise.

For an embodiment, a system 202 receives one or more merchandise destination locations from a user device 102. For an example, a transmission module 110 transmits one or more merchandise destination locations to a system 202 using techniques described herein. According to an embodiment, a system 202 receives information from a transmission module 110 that correlates one or more merchandise destination locations to one or more merchandise selected. For an example, a system 202 receives a list including selected merchandise and its merchandise destination location in the same row of the list. Another embodiment includes a system 202 configured to receive one or more merchandise destination locations such that each merchandise destination location corresponds to one or more merchandise references that indicate to a system 202 the merchandise that should be shipped to that merchandise destination location. For some embodiments, a merchandise reference indicates one or more merchandise. A merchandise reference includes, but is not limited to, a stock-keeping unit (“SKU”), a product code, a serial number, a pointer to or an address location in a list of merchandise information, a memory location that includes the merchandise information, and a document or a section thereof that includes merchandise information.

According to an embodiment, a rule module 210 receives one or more merchandise destination locations that corresponding to merchandise selected to be shipped or purchased. A rule module 210, according to an embodiment, determines a merchandise origin location by referencing one or more databases 216 or lookup tables using techniques described above. For example, for a merchandise selected for shipping a rule module 210 accesses a database 216 to retrieve a merchandise origin location. A merchandise origin location includes, but is not limited, to an address of a warehouse, a retailer, a manufacturer, a winery, or other location where the selected merchandise will ship from. A merchandise destination location may include information that corresponds to an address that merchandise is to be shipped to including, but not limited to, one of or any combination of a state, a city, a county, a zip code, a street address, a street number, a building name, country, postal code, latitude and longitude, or other information related to a location. Similarly, a merchandise origin location may include information that corresponds to an address where merchandise is to be shipped from including, but not limited to, one of or any combination of a state, a city, a county, a zip code, a street address, a street number, a building name, country, postal code, latitude and longitude, or other information related to a location

A rule module 210, for an embodiment, based on the determined merchandise origin location and a corresponding merchandise destination location determines a shipping time. According to an embodiment, a rule module 210 may reference one or more databases 216 or lookup tables that includes a shipping time that corresponds to a merchandise origin location and a merchandise destination location. For an embodiment, a database 216 or a lookup table may include a shipping time for each shipping option available for a selected merchandise based on a merchandise origin location and/or a merchandise destination location. A database 216 or lookup table, according to an embodiment, may include a shipping time in the form of an algorithm or equation to calculate a shipping time that corresponds to each shipping option based on a merchandise origin location and/or a merchandise destination location. For an example, for a determined merchandise origin location and a shipping option a database 216 or lookup table may include a multiplication factor to multiple the miles between the merchandise origin location and the merchandise destination location. As such, the shipping time would be based on a multiplication factor multiplied by the distance in miles that the shipment would travel from a merchandise origin to deliver the merchandise, for an embodiment. According to an embodiment, a shipping time stored in one or more databases 216 or lookup tables may be determined empirically, provided by a carrier service, using statistical analysis, or other methods for arriving at shipping times. For an embodiment, a rule module 210 is configured to transmit one or more shipping times to a date determination module 211 for one or more merchandise.

A rule module 210, according to some embodiments, may be configured to take into account federal regulations, state regulations, county regulations, business rules, regional preferences, or other criteria for selecting available shipping options. For some embodiments, rule module 210 is configured to include state and/or county alcohol regulations including, but not limited to, price requirements, shipping requirements, quantity requirements, alcohol content requirements, and other requirements related to selling and distributing alcohol. According to some embodiments, rule module 210 is configured to include business rules related to aspects including, but not limited to, preferred carrier services, preferred shipping options, preferred shipping locations, price, gross margins, minimum quantities, cost of shipping, shipping rules based on merchandise origin location, shipping rules based on destination, user preferences, or user history, or other factors related to the business.

The embodiment illustrated in FIG. 2 also includes a date determination module 211. According to an embodiment, a date determination module 211 is configured to determine one or more dates of delivery for merchandise. A date determination module 211, according to an embodiment, is coupled with shipping options module 208 and rule module 210. As such, a date determination module 211 may receive input from shipping options module 208 that indicates the determined shipping options available to a user device 102. For an embodiment, a date determination module 211 may receive input from a rule module 210 that indicates a shipping time for the determined shipping options. Based on one or more inputs, a date determination module 211 determines one or more delivery dates for one or more items of merchandise selected for shipping or purchasing.

According to an embodiment, a date determination module 211 synchronizes delivery date of a plurality of merchandise selected for shipping based on one or more shipping times received from a rule module 210. For an embodiment, a date determination module 211 is configured to synchronize delivery of merchandise that correspond to a single order but is shipped from multiple locations, a split shipment. As such, a date determination module 211, according to an embodiment, is configured to receive a shipping time for each merchandise origin location determined by rule module 210. A date determination module 211, according to an embodiment, determines the longest shipping time and based on the longest shipping time determines one or more delivery dates such that the delivery of all merchandise selected is scheduled to arrive at the merchandise destination location on the same date. For an embodiment, a date determination module 211, is configured to determine more than one date that the delivery of all merchandise selected for shipping can be scheduled to arrive based on selected shipping options. As such, a date determination module 211 is configured to determine a delivery date for shipments of merchandise spit between more than one merchandise origin location but shipped to a single merchandise destination location.

For some embodiments, a date determination module 211 is configured to generate a shipping hold notification based on one or more determined shipping times for selected merchandise. According to an embodiment, a date determination module 211 is configured to generate a shipping hold notification to a merchandise origin location that includes merchandise selected for shipping from an group of merchandise selected to ship to the same merchandise destination location. For an embodiment, a date determination module 211 is configured to generate a shipping hold notification to a merchandise origin location that is determined to have the shortest shipping time.

According to another embodiment, a date determination module 211 may generate a shipping hold notification for all merchandise origin locations that correspond to a group of selected merchandise for shipping to a single merchandise destination location. Such a shipping hold notification includes an email, a notation in a database, information on a shipping label, information on shipping instructions, information on a waybill, or other indicator corresponding to shipping selected merchandise. According to embodiments, a shipping hold notification may include one of or a combination of a date to provided merchandise to a carrier service, a shipping speed, a shipping route, or other information related to synchronizing multiple shipments to arrive on a single delivery date. For an embodiment, a date determination module 211 is configured to determine a separate shipping speed for each separate merchandise origin location based on a delivery date to schedule each shipment to arrive on that delivery date.

According to an embodiment, a date determination module 211 generates one or more shipping hold notifications in response to a date selection input received from a user device 102. A date selection input includes information that corresponds to a selected delivery date selected from one or more determined delivery dates transmitted to a user device 102 by system 202. For an embodiment, a system 202 receives a selected delivery date based on user input received by date selection module using techniques described herein.

According to an embodiment as illustrated in FIG. 2, system 202 includes an update module 214. According to an embodiment, an update module 214 is coupled with one or more modules including, but not limited to, a shipping options module 208, a rule module 210, and a date determination module 211. An update module 214, according to an embodiment, is configured to receive information from one or more of the modules. For example, delivery date information may be received from a date determination module 211 in one or more formats including those described herein. In addition, shipping options information may be received from a shipping options module 208.

According to another embodiment, a update module 214 is configured to aggregate information from one or more of modules. An update module 214 may aggregate information from one or more modules by using techniques including, but not limited to, generating pointers to all information stored in one or more memories, creating a document to include all information, writing all the information into memory, appending new information to information previously generated, and other techniques for gathering and storing information.

According to an embodiment, an update module 214 is coupled with a rule module 210 and is configured to receive rule information from a rule module 210. According to some embodiments, rule information may include, but is not limited to, a variable, a pointer, an address, a reference, a function call or other information that corresponds to one or more rules to apply to aggregated information. Based on the received rule information from a rule module 210, an update module 214 determines the content information to send to a user device 102. According to an embodiment, an update module 214 performs a search of a database of weather information, shipping information, or merchandise information that corresponds to the rule information to generate a set of information to transmit to a user device 102. For another embodiment, information may be preselected and associated with rule information from a rule module 210. Such an embodiment would access the set of information, for example by retrieving the information from a memory, a database, or an external server, to form content information. For some embodiments, an update module 214 may exclude information aggregated from one or more modules based on rule information received from a rule module 210 to form content information. Similarly, an update module 214 may include information aggregated from one or more modules in a database based on rule information received from a rule module 210.

A system 202, according to the embodiment illustrated in FIG. 2, includes a format module 212 coupled with an update module 214. According to an embodiment, format module 212 is configured to receive aggregate information from update module 214. An update module 214 may be received in one or more formats including those described herein. Format Module 212, according to an embodiment, is configured to transform the aggregate information into a format for a user device 102. For one example, format module 212 may transform content from a database format into a markup language format for viewing on a client application, such as a web browser, on a user device 102. For some embodiments, format module 212 converts the aggregate information received from update module 214 into a compatible version of HTML or XHTML for a client application 104.

According to some embodiments, a format module 212 is configured to append some or all of the aggregated information received from an update module 214 with cascading style sheets, scripts, or other format information to instruct a client application 104 how to display or format the information. A format module 212, according to an embodiment, may determine changes in aggregate information received from an update module 214 based on one or more sets of information previously transmitted to a user device 102. As such, a format module 212 may prepare the updated or changed information from the previously sent information into a format for the client application. As such, the previously transmitted information is not transmitted to a user device 102. According to an embodiment, a format module 212 determines any changes in content information from a set previously sent to a user device 102 based on a cookie, token, log, or other record of content information transmitted to a user device 102.

For an embodiment, format module 212 may be configured to receive information from one or more of the modules in system 202. For example, format module 212 may be configured to receive determined shipping options from a shipping options module 208, and/or delivery dates from a date determination module 211. Format module 212 is configured to transform the information received from the one or more modules using techniques described herein. The formatted information, according to an embodiment, is then transmitted to a communication interface 206 for transmission to one or more clients 102. Thus, according to an embodiment, a user device 102 would receive the formatted information for viewing as a webpage or section of a webpage on a user device 102.

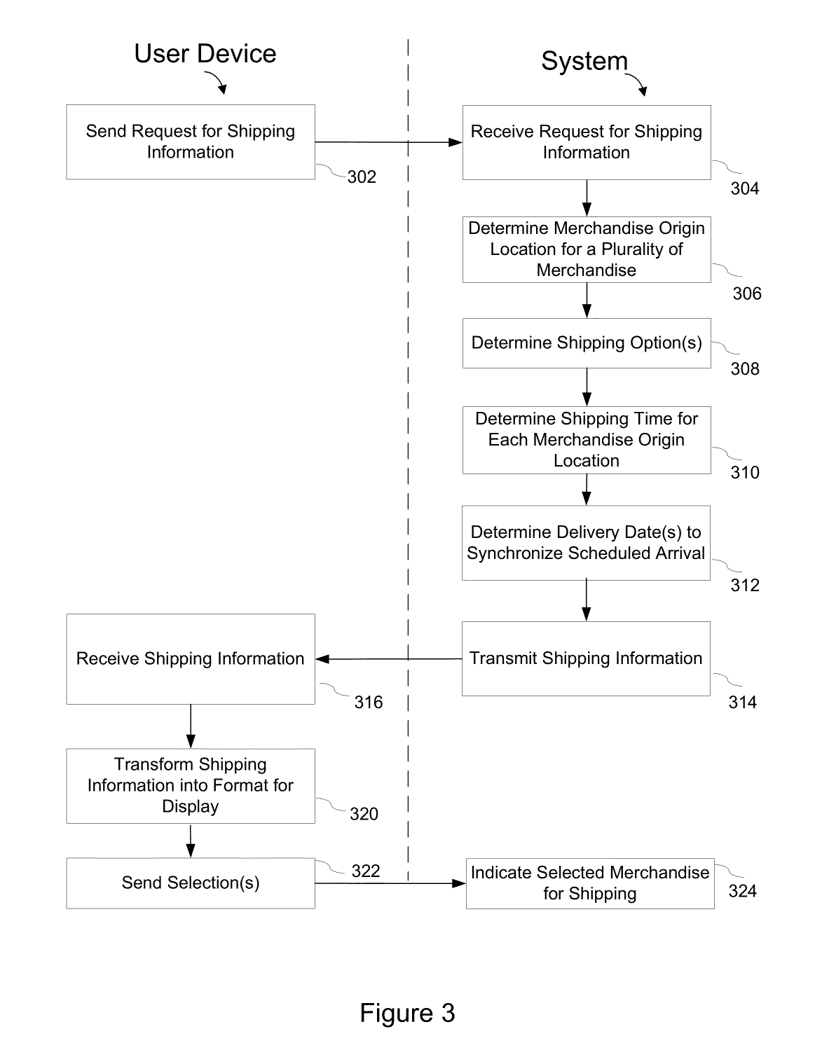

FIG. 3 illustrates a flow diagram for determining shipping information according to an embodiment. At block 302, a user device sends a request for shipping information 302 for a plurality of merchandise. Such a request includes, but is not limited to, requesting a URL to view a webpage such as a shopping cart page, accessing an FTP site, selecting merchandise for purchase, adding merchandise to a shopping cart and otherwise accessing a resource on a remote system. As described above, the request may be generated by a client application responsive to a user input, for example entering a URL, selecting a button, entering text in a text box, or through another technique for a user to interface with a user device or application. A system receives the request at block 304. In response to the received request, a system determines a merchandise origin location for a plurality of merchandise at block 306 using techniques described herein. According to an embodiment, a request for shipping information includes at least two merchandise references each corresponding to a merchandise for shipping. A system determines shipping options at block 308, according to an embodiment, using techniques such as those described herein. For an embodiment, a system determines shipping options for each determined merchandise origin location.

At block 310, a system, according to an embodiment, determines a shipping time for delivering merchandise from each determined merchandise origin location, as described herein. For an embodiment, a system determines a shipping time for each shipping option available for shipping selected merchandise from each determined merchandise origin location using techniques described herein. A system, at block 312, may also determine one or more delivery dates for a plurality of merchandise having at least two merchandise origin locations. According to an embodiment, a system determines one or more delivery dates such that for each determined delivery date the plurality of merchandise shipping from the at least two merchandise origin locations can be scheduled to arrive on that date using techniques described herein. As such, a system determines delivery dates to synchronize the shipment of a plurality of merchandise having at least two merchandise origin locations such that the scheduled arrival is for the same day, according to an embodiment.

At block 314, a system, according to an embodiment, transmits shipping information that includes at least one of the determined shipping options, the determined shipping time, and the determined delivery dates that synchronize the arrival of a plurality of merchandise shipping from at least two merchandise origin locations, using techniques described herein. According to some embodiments, the shipping information is transmitted with information for generating a document on a user device, such as HTML, XHTML, pictures and/or other instructions that instruct a client application to generate a document for viewing on a user device. A user device receives the shipping information at block 316. The shipping information is transformed into a format for display at block 320 using techniques described herein. According to an embodiment, a user device is configured to send one or more selections including one of or a combination of one or more selected shipping options and one or more selected delivery dates at block 322. A system, at block 324, indicates the selected merchandise for shipping according to the received selections, according to an embodiment.

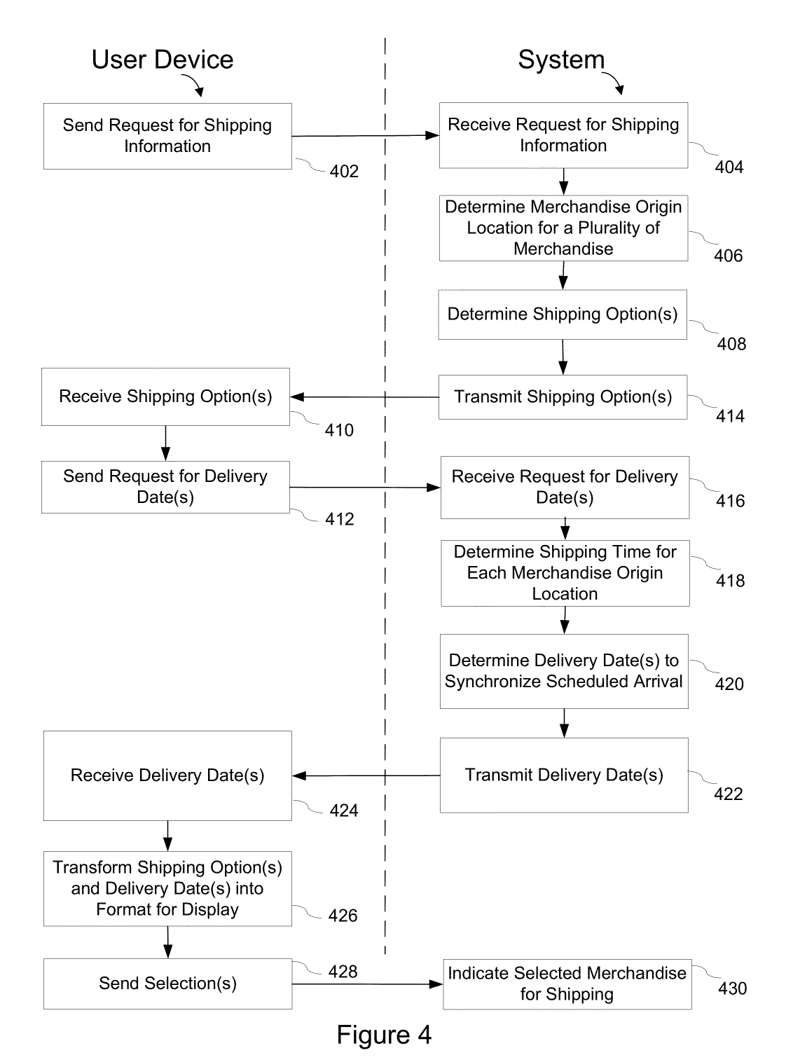

FIG. 4 illustrates a flow diagram for determining shipping information and determining delivery dates according to an embodiment. At block 402, a user device sends a request for shipping information for a plurality of merchandise, for example, using techniques as described herein. A system receives the request for shipping information at block 404. According to an embodiment, a request for shipping information includes at least two merchandise references each that correspond to a merchandise for shipping. Responsive to the request for shipping information, at block 406, a system determines a merchandise origin location for a plurality of selected merchandise using techniques described herein. At block 408, a system, according to an embodiment, determines shipping options as described herein. For an embodiment, a system determines shipping options for each determined merchandise origin location.

According to an embodiment, a system transmits shipping options determined by a system to a user device at block 414. For an embodiment, transmitting shipping options includes formatting shipping options, for example by using techniques described herein. For an embodiment, the shipping options are determined based on each determined merchandise origin location using techniques described herein. At block 410, a user device receives the shipping options. According to some embodiments, receiving the shipping options includes transforming the shipping options received from the system for display on a user device using techniques described herein.

At block 412, a user device sends a request for one or more delivery dates for a plurality of merchandise having at least two merchandise origin locations using techniques described herein. For an embodiment, sending a request for one or more delivery dates is in response to receiving the shipping options. According to some embodiments, sending a request for one or more delivery dates is responsive to a user input. For example, a user input may include, but is not limited to, selecting one or more shipping options, selecting an icon or button, inputting a destination address in a text box to ship merchandise, or other user interaction with a user device or application. A system receives the request for one or more delivery dates at block 416 and responsive to the request, the system determines a shipping time for delivering merchandise from each determined merchandise origin location at block 418, such as using techniques described herein.

For an embodiment, a system determines a shipping time for each determined shipping option available for shipping merchandise from each determined merchandise origin location using techniques described herein. At block 420, a system determines one or more delivery dates for a plurality of merchandise having at least two merchandise origin locations using techniques described herein. According to an embodiment, a system determines one or more delivery dates such that for each determined delivery date the plurality of merchandise shipping from the at least two merchandise origin locations can be scheduled to arrive on that date using techniques described herein. As such, a system determines delivery dates to synchronize the shipment of a plurality of merchandise having at least two merchandise origin locations such that the scheduled arrival is for the same day, according to an embodiment.

The one or more determined delivery dates are transmitted at block 422, for example by using techniques described herein. According to some embodiments, transmitting one or more delivery dates includes formatting delivery dates, such as using techniques as described herein. A user device receives the one or more delivery dates at block 424 and transforms the one or more delivery dates into a format for display at block 426, for example by using techniques described herein. According to an embodiment, a user device is configured to send one or more selections including one of or a combination of one or more selected shipping options and one or more selected delivery dates at block 428. A system, at block 430, indicates the selected merchandise for shipping according to the received selections, according to an embodiment.

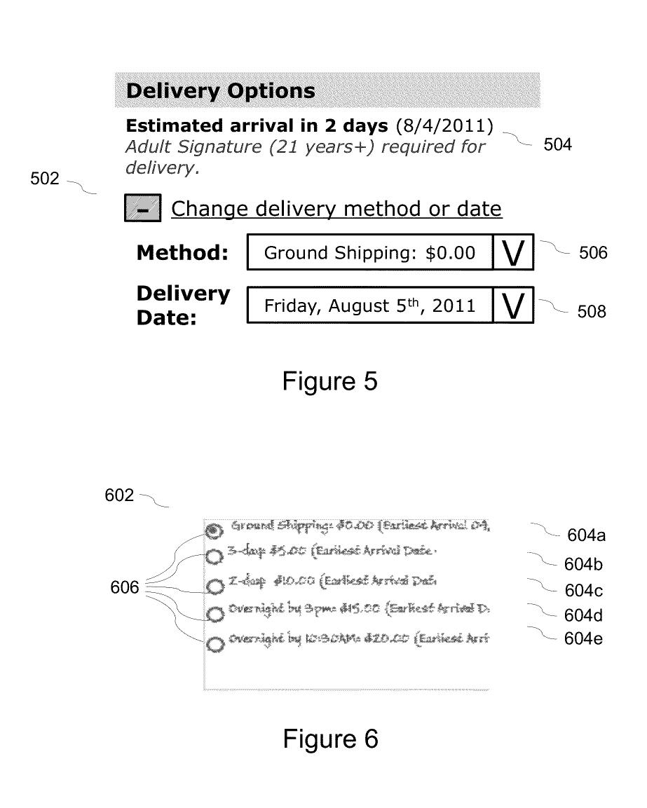

FIG. 5 illustrates an embodiment of a document 502 generated to display determined shipping options and one or more determined delivery dates. The document 502 includes content information 504 that may include, but is not limited to, one or more estimated arrival dates, legal information, product information, shipping information, or information related to shipping or delivery of merchandise. Content information, according to an embodiment, is generated based on one or more business rules. According to an embodiment the content information generated may include product information based on one or more business rules determined based on location information. For example, content information 504 may provide availability information of a product currently in inventory based on a business rule requiring the predetermined profit margin be above a threshold for the determined location.

Content information 504 may be generated, in whole or in part, based on one or more business rules that the product is available in a preferred shipping location for the determined location, according to an embodiment. Another example includes content information 504 which may be generated based one or more business rules that provide the viewing of products that can be obtained, for example from business partners, but is not currently in inventory. In some embodiments, product information, such as content information 504, may include information of products available regardless of determined location.

For an embodiment, document 502 also includes one or more shipping options 506 displayed as a drop-down menu. Some embodiments include displaying shipping options 506 in the format of a list, a grid, a window, or any other manner for presenting information. Shipping options 506, according to an embodiment, are determined shipping options received from a system using techniques as described herein. For some embodiments, the format of shipping options 506 displayed in document 502 is based on format information received with the determined shipping options from a system using techniques described herein. Another embodiment includes the format of shipping options 506 displayed in a document 502 based on format information of an application on a user device.

As illustrated in the embodiment in FIG. 5, document 502 also includes a one or more delivery dates 508 displayed as a drop-down menu. Some embodiments include displaying delivery dates 508 in the format of a list, a grid, a window, or any other manner for presenting information. Delivery dates 508, according to an embodiment, are determined delivery dates received from a system using techniques as described herein. For some embodiments, the format of delivery dates 508 displayed in document 502 is based on format information received with the determined delivery dates from a system using techniques described herein. Another embodiment includes the format of delivery dates 508 displayed in a document 502 based on format information of an application on a user device.

For some embodiments, document 502 is configured such that a user may select one or more delivery dates and/or one or more shipping options displayed. According to an embodiment, a user may select one or more delivery dates and/or one or more shipping options by using a user interface. Document 502, according to an embodiment, is configured such that a user selection is transmitted back to a server or system using techniques described herein.

FIG. 6 illustrates a list of determined shipping options and delivery options 602 according to an embodiment. Such a list includes both merged determined shipping options and determined delivery dates for each list element 604a-e. For some embodiments, a user device is configured to transform determined shipping options and determined delivery date information received from a system to merge related shipping options information and delivery date information into a single list element 604a-e. According to other embodiments, a system is configured to transmit merged shipping options information and delivery date information in a format or with format information using techniques described herein such that a user device displays a list that includes both shipping options information and delivery date information as a single list element 604a-e. The embodiment of a list of determined shipping options and delivery options 602 as illustrated in FIG. 6 also includes selectable fields 606 each corresponding to a list element 604a-e. A selectable field 606 includes, but is not limited to, a radio button, a check box, a button, and other selectable features. According to an embodiment, a selectable field 606 is configured to respond to user input through a user interface. For some embodiments, list element 604a-e is configured to respond to user input through a user interface, such as being a selectable list element.

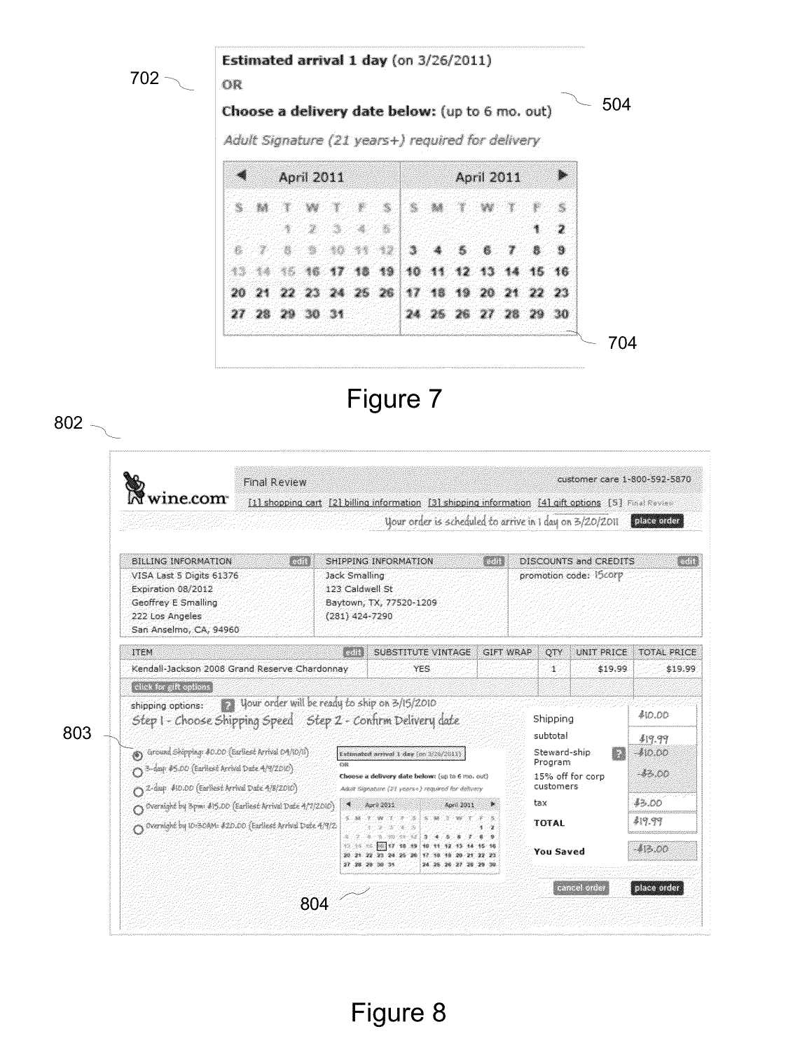

FIG. 7 illustrates a graphic user interface (“GUI”) for selecting a delivery date 702 according to an embodiment. The graphic user interface for selecting a delivery date 702, according to an embodiment, includes content information 504, as described herein. According to an embodiment, a graphic user interface for selecting a delivery date 702 includes a selectable field 704 configured to receive user input through a user interface to select a delivery date. For an embodiment as illustrated in FIG. 8, selectable field 704 is configured as a calendar. According to some embodiment, selectable field 704 includes one or more determined delivery dates. Determined delivery dates may be determined by a system using one or more techniques described herein. For some embodiments, dates available for delivering merchandise are displayed using different formatting to visually distinguish available dates from the unavailable dates. Formatting used to display available date for delivering merchandise includes, but is not limited to, font, color, borders, shading, and other indicators to set available dates apart from the other dates. According to embodiments, graphic user interface for selecting delivery dates 702 is generated using techniques described herein.

FIG. 8 illustrates a graphic user interface for a shopping cart 802 that includes determined shipping information according to an embodiment. According to an embodiment, determined shipping information is integrated into a document such as a GUI for a shopping cart 802 used for purchasing merchandise. FIG. 8 illustrates a GUI that includes determined shipping information integrated into the GUI as a list of determined shipping options and delivery options 803 and a GUI for selecting a delivery date 804 using techniques as described herein. As such, a system may provide to an application determined shipping information and/or format information to use to generate a GUI that integrates the information into a document.

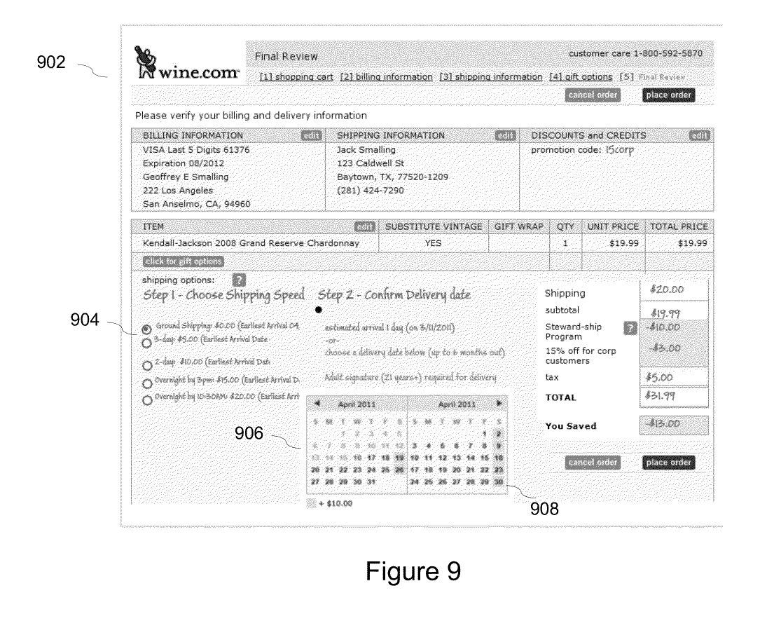

FIG. 9 illustrates a GUI for a shopping cart that includes determined shipping information with format information based on business rules 902. The GUI of FIG. 9 includes determined shipping information integrated into a document as a list of determined shipping options and delivery options 904 and a GUI for selecting a delivery date 906. For an embodiment, a system generates the determined shipping information with format information based on business rules 902 using techniques described herein. For example, formatting based on business rules 908 may be generated from format information based on business aspects of shipping such as pricing for shipping options. As illustrated in FIG. 9, a GUI for selecting a delivery date 906 includes formatting based on business rules 908 to indicate a price difference from other available delivery dates.

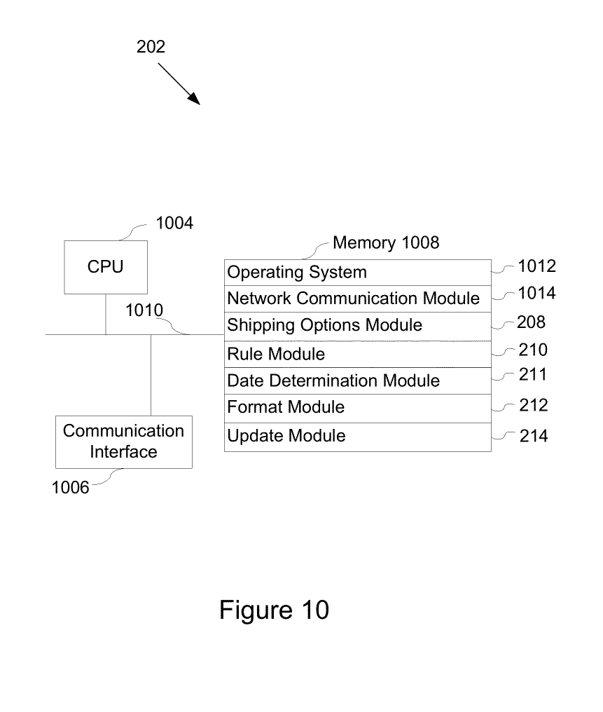

FIG. 10 illustrates an embodiment of a system 202 that implements the methods and techniques described herein. The system, according to an embodiment, includes one or more processing units (CPUs) 1004, one or more networks or other communication interfaces 1006, a memory 1008, and one or more communication buses 1310 for interconnecting components and modules. The system 202 may optionally include a user interface comprising a display device and a keyboard (not shown). The memory 1008 may include high speed random access memory and may also include non-volatile memory, such as one or more magnetic or optical storage disks. The memory 1008 may include mass storage that is remotely located from CPUs 1004. Moreover, memory 1008, or alternatively one or more storage devices (e.g., one or more nonvolatile storage devices) within memory 1008, includes a computer readable storage medium. The memory 1008 may store the following elements, or a subset or superset of such elements:

an operating system 1012 that includes procedures for handling various basic system services and for performing hardware dependent tasks;

a network communication module (or instructions) 1014 that is used for connecting the system 202 to other computers, clients, systems or devices via the one or more communication interfaces 1006 (wired or wireless), such as the Internet, other wide area networks, local area networks, metropolitan area networks, and other type of networks;

a shipping options module 208 for determining one or more shipping options as described herein;

a rule module 210 for determining one or more rules as described herein;

a date determination module 211 for determining one or more delivery dates as described herein;

a format module 212 for transforming shipping information and content information into a format for a user device as described herein; and

an update module 214 for generating and/or aggregating information as described herein.

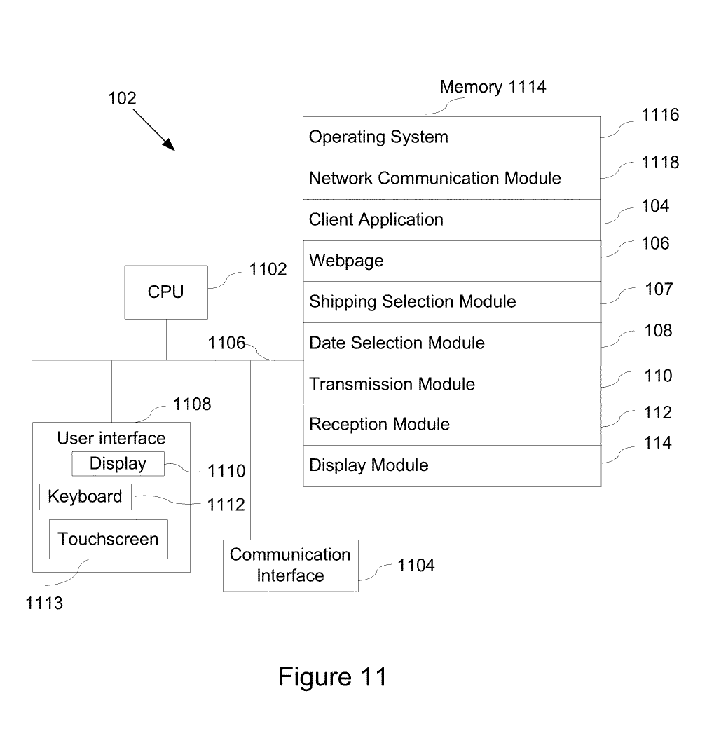

FIG. 11 illustrates an embodiment of a client or user device 102 that implements the methods described herein. The client, according to an embodiment, includes one or more processing units (CPUs) 1102, one or more network or other communication interfaces 1104, memory 1114, and one or more communication buses 1106 for interconnecting these components. The user device 102 may optionally include a user interface 1108 comprising a display device 1110, a keyboard 1112, touchscreen 1113, and/or other input/output devices. Memory 1114 may include high speed random access memory and may also include non-volatile memory, such as one or more magnetic or optical storage disks. The memory 1114 may include mass storage that is remotely located from CPUs 1102. Moreover, memory 1114, or alternatively one or more storage devices (e.g., one or more nonvolatile storage devices) within memory 1114, includes a computer readable storage medium. The memory 1114 may store the following elements, or a subset or superset of such elements:

an operating system 1116 that includes procedures for handling various basic system services and for performing hardware dependent tasks;

a network communication module (or instructions) 1118 that is used for connecting the user device 102 to other computers, clients, systems or devices via the one or more communication network interfaces 1104 and one or more communication networks, such as the Internet, other wide area networks, local area networks, metropolitan area networks, and other type of networks;

a client application 104 including, but not limited to, a web browser, a document viewer or other application for viewing information;

a webpage 106 as described herein;

a shipping selection module 107 for requesting shipping options and receiving input as described herein;

a date selection module 108 for requesting delivery dates and receiving input as described herein;

a transmission module 110 for transmitting and/or transforming a request as described herein;

a reception module 112 for receiving content information as described herein; and

a display module 114 for transforming content information into a format for viewing on a user device as described herein.

Although FIGS. 10 and 11 illustrate a client system 102 and a server system 202, the figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 11 could be implemented on a single server and single items could be implemented by one or more servers. The actual number of servers or modules used to implement server system 202 and how features are allocated among them will vary from one implementation to another, and may depend in part on the amount of data traffic that the system must handle during peak usage periods as well as during average usage periods. In addition, some modules or functions of modules illustrated in FIG. 11 may be implemented on one or more one or more servers remotely located from other servers that implement other modules or functions of modules illustrated in FIG. 11.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system to synchronize delivery of shipments comprising:
memory;
one or more processors; and
one or more modules stored in memory and configured for execution by the one or more processors, the modules comprising:
a rule module configured to determine at least two merchandise origin locations based on an input received from a user device;
a date determination module coupled with said rule module, said date determination module configured to receive said at least two merchandise origin locations from said rule module and configured to determine at least one delivery date for delivery to a merchandise destination location such that a first merchandise at a first merchandize origin location and a second merchandize at a second merchandise origin location are scheduled to arrive at said merchandise destination location on said determined at least one delivery date; and
a format module configured to transform said at least one delivery date into a format for said user device.

2. The system of claim 1 further comprising a shipping options module configured to determine at least one shipping option based on said input received from said user device.

3. The system of claim 1, wherein said input is generated in response to a user selection on said user device.

4. The system of claim 1, wherein said input is generated in response to a user selecting merchandise for purchase.

5. The system of claim 1, wherein said date determination module is configured to generate a shipping hold notification.

6. The system of claim 5, wherein said date determination module is configured to transmit a shipping hold notification to at least one of said at least two merchandise origin locations.

7. The system of claim 6, wherein said input includes merchandise destination location including latitudinal and longitudinal information.

8. The system of claim 2, wherein said date determination module is further configured to determine said at least one delivery date based on said at least one shipping option.

9. The system of claim 2, wherein said date determination module is further configured to determine said at least one delivery date also based on said at least one rule.

10. The system of claim 1, wherein said rule module is further configured to determine said at least two merchandise origin locations based on a profit margin.

11. The system of claim 9, wherein said shipping option module is further configured to determine said at least one shipping option also based on said at least one rule.

12. The system of claim 1, wherein said input includes information corresponding to a type of merchandise and a merchandise destination location.

13. The system of claim 9, wherein said rule module generates one or more rules based on said merchandise destination location are related to alcohol regulations for said merchandise destination location.

14. A retail system comprising:
memory;
one or more processors; and
one or more modules stored in memory and configured for execution by the one or more processors, the modules comprising:
a rule module configured to determine a plurality of merchandise origin locations based on an input received from a user device;
a date determination module coupled with said rule module, said date determination module configured to receive from said rule module at least two distinct merchandise origin locations corresponding to at least two merchandise and configured to determine at least one delivery date to a merchandise destination location such that such that the at least two merchandise are scheduled to arrive at said merchandise destination location on said determined at least one delivery date; and
a format module configured to transform said at least one delivery date into a format for said user device.

15. The retail system of claim 14, wherein at least one of said plurality merchandise origin locations is based on a preferred warehouse.

16. The retail system of claim 14, said rules module is configured to generate one or more business rules based on said input.

17. The retail system of claim 14, wherein said date determination module is configured to generate a shipping hold notification.

18. The retail system of claim 14, wherein said input includes information related to type of merchandise selected for shipping.

19. The retail system of claim 16, wherein said format module transforms said at least one delivery dates into a list of available delivery dates.

20. A method for determining shipping information for a merchandise comprising:
while executing a client application on a user device,
sending a request for a delivery date for a plurality of merchandise to a system configured to determine said delivery date;
in response to said request for said delivery date, receiving at least one delivery date based on a plurality of merchandise origin locations corresponding to said plurality of merchandise such that said plurality of merchandise is scheduled to arrive on said at least one delivery date; and
transforming said at least one delivery date into a format for displaying on said user device.

21. The method of claim 20, wherein said client application is a web browser.

22. The method of claim 20, wherein transforming said at least one delivery date for displaying on said user device includes rendering markup language for viewing on said user device.

23. The method of claim 20, wherein said at least one delivery date is determined based on one or more rules.

24. A method comprising:
in response to receiving a request from a user device at a system, executing instructions on said system such that said system implements:
determining at least two merchandise origin locations based on said request received from said user device;
determining at least one delivery date for delivery to a merchandise destination location such that a first merchandise at a first merchandize origin location and a second merchandize at a second merchandise origin location are scheduled to arrive at said merchandise destination location on said determined at least one delivery date; and
transforming said at least one delivery date into a format for said user device.

25. The method of claim 24 further comprising determining at least one shipping option based on said request received from said user device.

26. The method of claim 24, wherein said request is generated in response to a user selection on said user device.

27. The method of claim 25, wherein determining said at least one delivery date is based on said at least one shipping option.

28. The method of claim 24 further comprising determining at least one rule responsive to said request.

29. The method of claim 28, wherein determining said at least one delivery date is based on said at least one rule.

30. The system of claim 29, wherein determining said at least one shipping option is also based on said at least one rule.
